(19) United States
(12) Patent Application Publication
(10) Pub. No.: US 2009/0111041 A1
(43) Pub. Date: Apr. 30, 2009

(54) ELECTROPHOTOGRAPHIC TONER

(75) Inventor: Masaya Iwanabe, Shizuoka-shi (JP)

Correspondence Address: WOOD, HERRON & EVANS, LLP, 2700 CAREW TOWER, 441 VINE STREET, CINCINNATI, OH, 45202, US

(73) Assignee: TOMOEGAWA CO., LTD., Tokyo (JP)

(21) Appl. No.: 11/996,553

(22) PCT Filed: Jul. 24, 2006
(86) PCT No.: PCT/JP2006/314551

§ 371 Date: Jan. 23, 2008

(30) Foreign Application Priority Data
Jul. 25, 2005 (JP) 2005-213638

(51) Int. Cl. G03G 9/083

(52) U.S. Cl. 430/108.3

(57) ABSTRACT

The purpose of the present invention is to provide an electrographic toner, which is used for an image forming method of electrophotography, and particularly, used for mono-component development. The toner has a stable charge property, can form a toner layer on a developing sleeve wherein the thickness thereof is suitable and uniform, can achieve long-life property while a high image density is maintained (an image having a high image density is printed even when a large number of printings are conducted in succession), and achieves small toner consumption. In order to achieve this, an electrophotographic toner is proposed wherein at least inorganic particles, conductive metal oxide fine particles and carbon black are adhered to the surface of matrix toner particles, and the inorganic particles are surface-treated with cyclic silazane and have the specific surface area of 100 to 175 m²/g. It is preferable that the toner has the degree of circularity of 0.890 to 0.975.

### TECHNICAL FIELD

The present invention relates to an electrophotographic toner which is usable for an image forming method which uses electrophotography.

### BACKGROUND ART

In general, electrophotography is a method wherein an electrostatic latent image is formed on a photoconductor, and the latent image is developed with a charged toner to form a toner image, and then, the toner image is transferred on a transfer material such as paper, and the transferred toner image is fixed on the transfer material due to a method such as a heating or pressure-applying method to obtain a copied image. Examples of a developer which can be used for such electrophotography include a mono-component developer merely including a toner component, and a two-component developer which includes a toner component and a carrier component.

The two-component developer is excellent in electrophotographic characteristics such as transfer properties, fixing properties and environment resistance. However, it is necessary to control the mixing ratio of the toner component and the carrier component. Therefore, there are problems such that development equipment tends to be large and complicated, since it is necessary to further provide to the development equipment a toner concentration sensor and a mixing device which is used for mixing the toner component and the carrier component in order to control the mixing ratio of the toner component and the carrier component. Furthermore, there is a problem such that a two-component developer has a short life since a toner and a carrier included in the developer tend to deteriorate comparatively early due to the mixing and stirring steps conducted for the developer.

A mono-component development has been proposed and practically used, by which problems caused in the two-component developer have been overcome and in which electrophotographic characteristics and miniaturization and simplification of the development equipment are achieved. As the mono-component development, there are a contact-type development and a non-contact-type development. In the contact-type development, a charged toner being held on a developing sleeve is made to contact with a photoconductor, on which a latent image is formed, and then a toner image is developed by transferring the toner from the sleeve to the photoconductor. In the non-contact-type development, a non-magnetic sleeve and a photoconductor are provided in a non-contact manner such that a gap having a predetermined length is formed between them, and then, a toner held on the non-magnetic sleeve is pulled onto a latent image formed on the photoconductor.

Developing properties of the contact type mono-component development is good since a photoconductor is contacted with a toner being held on the developing sleeve. However, in the method, the toner is subjected to friction produced between a toner and a photoconductor in addition to friction which is caused when the toner is mixed in a development equipment. Accordingly, the mechanical burden applied to the toner is large, and there are problems such that the durability of toner becomes poor (short life of developer), and when a photoconductor is an organic photoconductor (OPC), the OPC tends to be damaged. Accordingly, when the aforementioned problems are taken into account, the non-contact type mono-component development is more preferable than the contact type mono-component development.

On the other hand, in the non-contact type mono-component development, mechanical burden applied to the toner is small, and contact between the toner and the developing element merely occurs between the toner and a blade used for charging. However, sufficient image density cannot be achieved in the non-contact type development since toner is required to be pulled over said gap when the development is conducted, and therefore, the developed amount achieved in the development is poor compared with that of achieved in the contact type development.

As a method for solving the above problems, a development equipment has been studied wherein the gap between a developing sleeve and a charging blade is expanded in order to increase the passible amount of a toner. However, when the passing amount of toner increases in this manner, the triboelectric charge amount of the toner becomes insufficient since charge injection to the toner achieved by the charging blade is carried out insufficiently, and therefore, a thin layer of the toner formed on the developing sleeve becomes ununiform. When development is conducted to form a sold image, a half-tone image or the like on a sheet while the thin toner layer is ununiform, problems are caused such that an image which looks as if it has been rubbed is formed and image density is partially insufficient. Furthermore, this problem may also be caused even in a contact type development, when a toner layer formed on a sleeve is thin but ununiform.

Accordingly, in the mono-component development, it is important that the thickness of a toner layer formed on a developing sleeve is adequate and uniform; charge amount of a charged toner is adequate and stable; and long-life is achieved while high image density is maintained (an image having a high image density can be printed in succession even when a large number of printings are printed). Furthermore, copy cost is also important, and it is required that a toner amount consumed is reduced, and long life is also achieved while a high image density is maintained.

In order to achieve high image density, long life, decrease of the toner consumption and the like, toner is required that an adequate and well-balanced charge amount can be maintained over a long period of time. In order to achieve such a toner, the addition of various fine particles to a matrix toner particle have been conducted conventionally. However, it is not easy to select the optimum amount and type of fine particles, and actually, sufficient results cannot be achieved easily.
Patent Document 1: Japanese Unexamined Patent Application, First Publication No. Hei 10-330115
Patent Document 2: Japanese Unexamined Patent Application, First Publication No. 2002-244340
Patent Document 3: Japanese Unexamined Patent Application, First Publication No. 2005-121867
Patent Document 4: Japanese Unexamined Patent Application, First Publication No. Hei 6-19191
Patent Document 5: Japanese Unexamined Patent Application, First Publication No. Hei 4-276762

### DISCLOSURE OF INVENTION

The purpose of the present invention is to provide an electrographic toner, which can show advantageous effects when the toner is used for electrophotographic image forming methods, especially for mono-component development. This advantageous effects are that the toner can have a stable charge property, and the toner can form a suitable toner layer wherein the thickness thereof formed on a developing sleeve is suitable and uniform, and the toner can achieve long-life while high image density is maintained (an image having high image density can be maintained while a large number of printings are conducted in succession), and toner consumption is small.

The electrophotographic toner of the present invention is a toner wherein at least inorganic particles, conductive metal oxide fine particles and carbon black are adhered to the surface of matrix toner particles, and the inorganic particles are surface-treated with cyclic silazane and have the specific surface area of 100 to 175 m²/g. The toner for electrophotography of the present invention is preferably a toner which has the degree of circularity of 0.890 to 0.975. The toner for electrophotography of the present invention is preferably used for mono-component development. The toner for electrophotography of the present invention is preferably used for non-contact type mono-component development. The toner for electrophotography of the present invention is preferably a magnetic toner.

The present invention can provide an electrophotographic toner which has stable charge property, and can form a suitable toner layer wherein the thickness thereof formed on a developing sleeve is suitable and uniform, and can achieve long-life while a high image density is maintained (an image having a high image density can be printed while a large number of printings are conducted in succession), and toner consumption is small.

### BRIEF DESCRIPTION OF THE DRAWINGS

FIG. 1 is a schematic view which shows an example of developing equipment which is usable for a non-contact, magnetic mono-component development method.

FIG. 2 is a schematic view which shows measuring equipment used for measuring the charged amount of an electrophotographic toner of the present invention.

FIG. 3 is a graph which shows the relationship between the number of printed sheets and the charge amount of a toner.

FIG. 4 is a graph which shows the relationship between the number of printed sheets and the image density of the printed sheet.

### BRIEF DESCRIPTION OF THE REFERENCE SYMBOLS

1: Photoconductor drum
2: Hopper
3: Magnetic toner (magnetic mono-component developer)
4: Charging blade
5: Magnetic roller
6: Nonmagnetic sleeve
7: Mixer
11: Developing roller (a sleeve is attached on the surface of the roller)
12: Toner
13: Vacuum equipment
14: Measuring equipment of triboelectric charge amount
15: Filter

### BEST MODE FOR CARRYING OUT THE INVENTION

The electrophotographic toner of the present invention is a toner wherein at least inorganic particles, conductive metal oxide fine particles and carbon black are adhered to the surface of matrix toner particles, and the inorganic fine particles are surface-treated with cyclic silazane and have a specific surface area of 100 to 175 m²/g.

The matrix toner particles of the present invention include at least a binder resin and a colorant.

Any binder resin can be used for the toner of the present invention insofar as it is used for a toner in general. Examples thereof include styrene based resins, polyacrylate based resins, styrene-acrylic acid ester copolymer resins, styrene-methacrylic acid ester copolymer resins, polyvinyl chlorides, polyvinyl acetates, polyvinylidene chlorides, phenol resins, epoxy resins, polyester based resins, hydrogenated rosins, olefin based resins, cycloolefin copolymer based resins, cyclorubbers, polylactic acid based resins and terpene-phenol resins. These resins may be used singly or in combination of two or more.

The electrophotographic toner of the present invention can include magnetic material if needed. General magnetic materials which have been used in a toner can be used in the present invention. Examples thereof include fine particles of; metals such as cobalt, iron and nickel; alloys such as those of aluminium, copper, nickel, magnesium, tin, zinc, gold, silver, selenium, titanium, tungsten, zirconium and other metals; and metal oxide such as aluminium oxide, iron oxide, nickel oxide, ferrite, magnetite and maghemite. Ferrite and magnetite are preferably used in the present invention, and magnetite is particularly preferable. As a powder of the ferrite, a mixed sintered material of MeO—Fe₂O₃ can be used in the present invention. The MeO represents oxide of Mn, Zn, Ni, Ba, Co, Cu, Li, Mg, Cr, Ca, V and the like, and one of or two or more kinds of MeO can be used for the present invention. As a powder of the magnetite, a mixed sintered material of FeO—Fe₂O₃ can be used in the present invention.

The average particle diameter of the magnetic material is preferably 0.05 to 3 μm, and 0.1 to 1 μm is more preferable. When the average particle diameter is less than 0.05 μm, exposure of the magnetic material included in a toner to air is too low, and as the result, the flow of electricity tends to deteriorate, the thickness of a toner layer provided on a developing sleeve tends to become uneven, toner consumption tends to increase, and/or fogging tends to be caused. When the average particle diameter exceeds 3 μm, a distribution of the magnetic material tends to become ununiform, fogging tends to be caused, and the image density tends to decrease. Furthermore, exposure of the magnetic material to air tends to increase excessively, and therefore, the surfaces abrasion of a photoconductor and a developing sleeve may be caused and a long-life property may not be achieved.

The evaluation method of the average particle diameter of the magnetic material is described below.

An electron micrograph of a magnetic material is taken using a scanning electron microscope (JSM-5300, manufactured by JEOL Ltd.). Then, one hundred magnetic materials are selected from the electron micrograph at random, and a long axis D and a short axis d of the magnetic materials are measured. Then, (D+d)/2 is calculated for each material independently, and the average thereof is provided as the average particle diameter.

Examples of the form of the magnetic material include spherical form, needle like form, hexahedral form, octahedral form, polyhedral form and atypical form. The form of the magnetic material is not limited in particular. Concrete examples which can be preferably used in the present invention include; hexahedral magnetic materials such as MTH-310 (trade name) manufactured by Toda Kogyo Corporation and octahedral magnetic materials such as EPT-500, EPT-1000, EPT-1001 and EPT-1002 (trade name) manufactured by Toda Kogyo Corporation.

When the magnetic material is used for forming a magnetic toner, the magnetic material is preferably included in an amount of 10 to 60% by weight in the matrix toner. When the magnetic material is used for forming a two-component developer, the magnetic material is preferably included in an amount of 10 to 35% by weight in a matrix toner for the developer. When the magnetic material is used for forming a mono-component developer, the magnetic material is preferably included in an amount of 25 to 60% by weight in the matrix toner, and 35 to 50% by weight is more preferable. When the magnetic material is less than 25% by weight, fogging tends to increase, and when the magnetic material exceeds 60% by weight, image density tends to decrease.

The electrophotographic toner of the present invention can include a colorant if needed. The colorant usable for the present invention is not limited in particular, and colorants which are generally used for a toner can be used for the present invention. Examples thereof include carbon black, aniline blue, chalcoil blue, chrome yellow, ultra marine blue, Du Pont oil red, quinoline yellow, methylene blue chloride, phthalocyanine blue, marachite green oxalate, lampblack and rose bengale.

It is necessary that a sufficient ratio of the colorant be added to the toner in order to form a visible image having sufficient image density. For example, the amount of a colorant included in a matrix toner particle is about 0.5 to 20% by weight, preferably 1 to 6% by weight, and more preferably 1 to 3% by weight. When a black toner is formed, a black magnetic material may be used as a colorant for forming the toner.

The electrophotographic toner of the present invention preferably comprises a wax in order to improve low-temperature fixing ability and releasing ability which is required at the time of fixing. Examples of the wax include; a polyolefin type wax such as a polyethylene wax and a polypropylene wax; a synthetic wax such as a Fischer-Tropisch wax; a petroleum wax such as paraffin wax and a microcrystalline wax; a vegetable wax such as carnauba wax, candelilla wax and rice wax; a hardened oil such as hardened castor oil; a mineral oil such as a montan wax, higher fatty acid and ester thereof; and fatty acid amide. Among them, in order to improve a releasing ability, the polyolefin type wax such as a polyethylene wax and a polypropylene wax and a modified wax thereof are preferably used. Examples of the modified wax include an oxidized wax and a graft-modified wax.

In order to fully satisfy the low-temperature fixing ability and releasing ability (off-set resistance and paper-wrapping resistance) required at the time of fixing, it is preferable that a low-melting point wax having the melting point of 60 to 105° C. and a high-melting point wax having the melting point of 115 to 150° C. are used in combination. It is more preferable that the melting point of the low melting point wax is 70 to 95° C., and the melting point of the high melting point wax is 125 to 145° C.

The vegetable wax and Fischer-Tropsch wax can be preferably used as the low-melting point wax. It is preferable that the Fischer-Tropsch wax is a natural gas type Fischer-Tropisch. The polyolefin type wax can be preferably used as the high melting point wax, and a polypropylene wax is particularly preferable.

The measurement of the melting point of a wax is conducted by a method according to ASTM D 3418-82, and described below.

About 5 mg of a sample are put into an aluminum cell, and the cell is set in a differential scanning calorimeter (DSC) (SSC-6200 (trade name), manufactured by Seiko Instruments Inc.). Then, N₂ gas is blown at a rate of 50 ml per one minute to the calorimeter, and then, heating is conducted gradually from 20 to 200° C. at the increasing ratio of 10° C./minute. When the temperature becomes 200° C., the temperature is maintained for 10 minutes, and subsequently, the temperature is lowered from 200 to 20° C. at the decreasing ratio of 10° C./minute. Then, the sample is heated again in accordance with the above conditions, and the apex of the endothermic peak evaluated at the time of the second heating is determined as the melting point of the sample. When there are several endothermic peaks, the highest endothermic peak is used to determine the melting point of the sample.

It is preferable that 0.5 to 15% by weight of a wax is included in a matrix toner particle, more preferably 1 to 10% by weight, and still more preferably 2 to 6% by weight. When the content of wax is less than 0.5% by weight, the wax tends not to contribute sufficiently to improve the low-temperature fixing ability and/or the releasing ability. When the content of the wax exceeds 15% by weight, problems regarding the preservation stability tend to be caused. Furthermore, the wax tends to be removed from the toner, and problems such as black spots, filming or the like formed on a photoconductor tend to be caused.

The electrophotographic toner of the present invention can include a charge controlling agent if necessary. A charge controlling agent is added to a toner in order to provide polarity to the toner, and they are positive and negative charge controlling agents. The positive and negative charge controlling agents may be used together.

Examples of the charge controlling agent used for a positive toner include: a nigrosine dye, a quaternary ammonium salt, a pyridinium salt, azine, a triphenylmethane based compound and a low-molecular polymer having a cationic functional group. Examples of the charge controlling agent used for a negative toner include: an azo type metal complex and a salicylic acid based metal complex, a boron containing type complex and a low-molecular-weight polymer having an anionic functional group.

The charge controlling agent is preferably included in a binder toner particle in the amount of 0.1 to 5% by weight, and more preferably 0.5 to 2.5% by weight.

In the present invention, the inorganic fine particles which are surface treated with cyclic silazane are used for a toner as an outer-additive agent. Since the fine particles provide positive-charge to the toner, it is preferable that the toner of the present invention is a positive toner wherein a charge controlling agent which can provide positive charge to toner is used.

The electrophotographic toner of the present invention can be produced such that; the aforementioned materials and other materials, which can be used if needed, are compounded and mixed in the predetermined ratio, and then, the mixture is applied to steps such as melt-kneading, pulverizing and classifying in this order. The toner of the present invention may be produced by other granulation methods such as a spray-drying method and a polymerization method.

The average volume particle diameter (a volume 50% diameter evaluated with Coulter Multisizer II) of the electrophotographic toner of the present invention is preferably 5 to 12 μm, more preferably 6 to 10 μm and still more preferably 6 to 9 μm. When the average volume particle diameter of the toner of the present invention is less than 5 μm, there are a lot of ultra fine particles less than 5μm in the toner. Therefore, problems tend to be caused such as fogging, deterioration of image density, black spots, filming generated on a photoconductor, and/or melting-adhesion to a developing sleeve or a blade used for controlling a layer-thickness. On the other hand, when the volume-average particle diameter of the toner exceeds 12 μm, resolution of an image tends to deteriorate and a high quality image may not to be obtained.

The electrophotographic toner of the present invention preferably has the degree of circularity of 0.890 to 0.975, more preferably 0.900 to 0.960 and still more preferably 0.920 to 0.950. The degree of circularity is determined by the following formula (1). When the degree is less than 0.890, the flow ability of a toner tends to become insufficient, and image density tends to decrease since the insufficient flow ability causes the decrease of the charge amount of the toner. When the degree exceeds 0.975, the charge amount of a toner tends to become excessive, a formed image becomes too thick, and the toner consumption increases.

Degree of circularity=π×(Diameter of a circle which has the same area as an image of a particle to be evaluated)/Perimeter of the image of the particle (1)

The above measurement of the circular degree is conducted with the flow particle image analyzer (FPIA-2100 (trade name), manufactured by Sysmex Corporation).

The method for adjusting the degree of circularity from 0.890 to 0.975 is not limited in particular. However, for example, it is not preferable to use a method wherein pulverizing is conducted using the airflow type pulverizer (for example, JET MILL IDS (trade name), manufactured by Nippon Pneumatic Mfg. Co., Ltd.) to form a toner, and subsequently, the toner is allowed to stand at a high temperature atmosphere in which the surface of the toner may be softened or melted. The reason is that such a method results in that the number of steps required for producing a toner increases, bulky particles tend to be caused due to adhesion and cohesion between toner particles, and properties of the toner tend to deteriorate due to heat applied to the toner. In the present invention, a method is preferably used wherein pulverization is conducted using an impact type pulverizer such as Kriptron Eddy KTM-EX type manufactured by Kawasaki Heavy Industries, Ltd. in order to avoid such problems described above.

The electrophotographic toner of the present invention includes at least inorganic fine particles, conductive metal oxide particles and carbon black which are adhering to the surface of the toner particles as outer-additives. Furthermore, it is necessary that the inorganic fine particles have been surface treated with cyclic silazane and have a specific surface area of 100 to 175 m²/g. High charging is possible when the inorganic fine particles which have been surface treated with cyclic silazane are used, and furthermore, high image density can be achieved easily. It is preferable that the inorganic fine particles which have been surface treated with cyclic silazane have a specific surface area of 110 to 155 m²/g, and more preferably 115 to 150 m²/g. When a specific surface area of the inorganic fine particles is less than 100 m²/g, the primary particle diameter thereof tends to increase, flow ability tends to deteriorate, and the thickness of a toner layer formed on a sleeve tends to become ununiform. On the other hand, when a specific surface area exceeds 175 m²/g, the primary particle diameter thereof decreases, and therefore, the inorganic fine particles tend to be embedded in the surface of the toner, and suitable charge ability and flow ability of the toner is not maintained. As the result, when a large number of prints are repeated in succession, image density decreases gradually.

In the present invention, a specific surface area was measured according to the BET method. The method for measuring the specific surface area according to the BET method is described below.

The specific surface area is measured with a high accuracy automatic gas absorption measurement instrument (BELOSORP28 (trade name), manufactured by Bel Japan, Inc,). Ns gas which is an inert gas used as an absorption gas in the measurement. Concretely, the absorption amount Vm (cc/g) which is required for forming a mono-molecular layer on a sample is measured, and then, the BET specific surface area S (m²/g) is determined by using the following formula.

S=4.35×Vm (m²/g)

The cyclic silazane used for treating the inorganic fine particles is not particularly limited. For example, compounds disclosed in Japanese Unexamined Patent Application, First Publication No. Hei 10-330115 (Patent document 1) can be cited as examples thereof. As the cyclic silazane, a compound represented by the following general formula (1) can be used preferably.

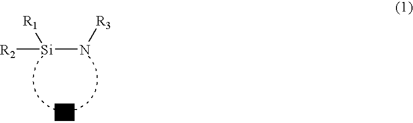

(R₁ and R₂ are groups each independently selected from the groups consisting of hydrogen, halogen, alkyl, alkoxy, aryl and aryl oxy; and R₃ is selected from the group consisting of hydrogen, (CH₂)ₙCH₃ (n represents an inter of 0 to 3), C(O)(CH₂)ₙCH₃ (n represents an integer of 0 to 3), C(O)NH₂, C(O)NH(CH₂)ₙCH₃ (n represents an integer of 0 to 3) and C(O)N[(CH₂)ₙCH₃](CH₂)ₘCH₃ (n represents an integer of 0 to 3); R₄ is represented by the formula: [(CH₂)ₐ(CHX)_{b}(CYZ)_{c}] (X, Y and Z are independently selected form the group consisting of hydrogen, halogen, alkyl, alkoxy, aryl and aryl oxy; and a, b and c represent an integer of 0 to 6 and the sum of a, b and c is equal to an integer of 2 to 6.)

Among the above cyclic silazane represented by the general formula (1), a compound represented by the general formula (2) shown below is more preferable.

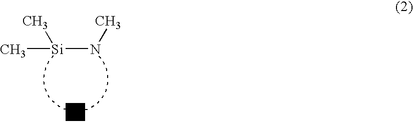

(R₄ is represented by the formula: [(CH₂)ₐ(CHX)_{b}(CYZ)_{c}] (X, Y and Z are independently selected from the group consisting of hydrogen, halogen, alkyl, alkoxy, aryl and aryl oxy; a, b and c represent an integer of 0 to 4, and the sum of a, b and c is equal to an integer of 3 or 4.)
The compound represented by the general formula (2) forms a five-membered ring or a six-membered ring.

Among compounds represented by the general formula (2), a compound represented by the following general formula can be most preferably used.

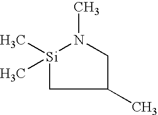

Examples of the inorganic fine particles used in the present invention include: silica, alumina, seria, germania, titania, zirconia, and any mixture thereof. Among them, silica and alumina are preferable and silica is most preferable.

As a method for treating the surface of the inorganic fine particles by cyclic silazane, a dry and wet methods well-known by a person skilled in the art can provide the uniform distribution of cyclic silazane on the surface of the inorganic fine particles, and can be used for the present invention. Examples of the dry method include a method wherein cyclic silazane and inorganic fine particles are stirred or mixed in a fluidized-bed reactor. Examples of the wet method include a method wherein inorganic fine particles are dispersed in a solvent to form an inorganic fine particle slurry, and subsequently, cyclic silazane is added to the slurry in order to modify the surface of the inorganic fine particles with the cyclic silazane. It is also possible to conduct the surface treatment of the inorganic fine particles such that cyclic silazane liquid or cyclic silazane vapor is contacted with inorganic fine particles, which are in a dried condition, using a batch method or succession method while they are mixed sufficiently. It is also preferable that, after the mixing thereof is conducted, the mixture of the inorganic fine particles and the cyclic silazane is maintained at the sufficient temperature and period required for modifying characteristics of the surface of the inorganic fine particles sufficiently. Typically, it was found that the temperature in the range of about 25 to 200° C. is adequate when the period for the surface treatment is in the range of about 30 minutes to about 16 hours. When the period is in the range of about 30 minutes to about 2 hours, the temperature within the range of about 80 to 100° C. is preferable, since it was found that characteristics of the surface of the inorganic fine particles can be modified effectively.

The inorganic fine particles used in the present invention should be treated with sufficient cyclic silazane in order to achieve the required level of the charge ability and the flow ability of an each toner composition or developer composition.

Furthermore, in order to make the surface of the inorganic fine particles to even more hydrophobic, a hydrophobic treatment may be performed on the inorganic fine particles. The kinds and amount of a hydrophobic agent used for the particles can be preferably selected in accordance with hydrophobic properties and other properties required. Examples of the hydrophobic agent include; organopolysiloxane, organosiloxane, organosilazane, organosilane, halogen-containing organopolysiloxane, halogen-containing organosiloxane, halogen-containing organosilazane and halogen-containing organosilane. Preferable examples thereof include dimethyl dichlorosilane, trimethoxyocthylsilane, hexamethyldisilazane and polydimethylsiloxane. The hydrophobic treatment may be conducted subsequent to the treatment wherein cyclic silazane is used.

It is preferable that the added amount of the inorganic fine particles, which have been treated with the cyclic silazane, to matrix toner particles is 0.3 to 3.0% by weight based on the matrix toner particles, more preferably 0.3 to 2.0% by weight and still more preferably 0.5 to 1.5% by weight.

When the amount is less than 0.3% by weight, image density is low at the initial stage, and furthermore, adequate image density is not maintained when printing is conducted in succession. When the amount exceeds 3.0% by weight, problems may be caused such that contamination of the photoconductor occurs and/or the thickness of a toner layer formed on a sleeve becomes ununiform.

The electrophotographic toner of the present invention is adhered by the conductive metal oxide fine particles on the surface thereof.

The conductive metal oxide fine particles function as an agent which makes possible to release easily a charge existing between toner particles. The conductive metal oxide fine particles can provide the stable charge ability to a toner. Therefore, said particles show the effect of forming a toner layer having uniform and adequate thickness on a developing sleeve, and as the result, toner consumption, image density and the like can be made adequately.

The conductive metal oxide fine particles used in the present invention are not limited in particular. The conductive metal oxide fine particles which are surface-treated with tin or antimony are preferably used. Concrete examples thereof include: tin and antimony doped conductive titanium oxide such as EC-100 T-IJ, ECT-52, ECT-62, ECTR-72, ECTT-1 and EC-300 (they are all manufactured by Titan Kogyo Corporation), ET-300, ET-500W, ET-600W, ET-300W, FT-1000, FT-2000, FT-3000, HJ-1 and HI-2 (they are all manufactured by Ishihara Sangyo Kaisha, Ltd.), and W-P (manufactured by Mitsubishi Materials Corporation); and antimony doped tin oxide such as SN-100P (manufactured by an Ishihara Sangyo Kaisha, Ltd.), T-1 (manufactured by Mitsubishi Materials Corporation.) and SH-S (manufactured by Nihon Kagaku Sangyo Co., Ltd.).

The average particle diameter of a primary particle of the conductive metal oxide fine particles is in general 0.01 to 1.0 μm, and preferably 0.1 to 0.6 μm. When the average particle diameter is too small, the generation of filming on a photoconductor may not be prevented, and when the average particle diameter is too large, flow ability may be deteriorate. The measurement of the average particle diameter is the same with the method described for the magnetic material.

It is preferable that the added amount of the conductive metal oxide fine particles is 0.3 to 3.0% by weight based on a matrix toner, and more preferably 0.5 to 1.5% by weight. When the amount is less than 0.3% by weight, problems tend to arise such that toner consumption increases and a sufficient flow ability of the toner is not achieved. When the amount exceeds 3.0% by weight, problems tend to arise such that image density decreases and contamination of a photoconductor is caused.

The electrophotographic toner of the present invention is required to be adhered by carbon black on the surface thereof. Although the charge amount of a toner depends considerably on the surface resistance of a matrix toner particle, control of the charge amount is conducted insufficiently if adjustment is conducted only by using inner additives included in the matrix toner particle. When carbon black is adhered to the surface of the toner particle, it decreases the surface resistance of the matrix toner particle, and therefore, thickness of a toner layer formed on a developing sleeve becomes suitable and uniform, and the charge amount can be stabilized to also stabilize image density.

The number average particle diameter, oil absorption, PH and the like of carbon black are not particularly limited. Examples of commercially available products thereof include; REGAL 400, 660, 330, 330R and 300, and STERLING SO, V, NS and R (trade names, manufactured by Cabot corporation (USA)); RAVEN H20, MT-P,410, 420, 430, 450, 500, 760, 780, 1000, 1035, 1060 and 1080 (trade names, manufactured by Columbia Carbon Japan); and #5B, #10B, #40, #2400B and MA-100 (trade names, manufactured by Mitsubishi Kasei Corporation). These carbon black may be used singly or in combination of two or more.

The adhered amount of carbon black to matrix toner particles is preferably 0.05 to 0.5% by weight, more preferably 0.1 to 0.3% by weight, and still more preferably 0.1 to 2% by weight, based on the matrix toner particles. When the amount thereof is less than 0.05% by weight, a toner layer formed on a developing sleeve tends to be ununiform and/or toner consumption tends to increase. When the amount thereof exceeds 0.5% by weight, problems tend to be caused such that image density decreases, suitable image density is not maintained when printing is conducted in succession, and fogging generates.

In addition to the inorganic particles, carbon black and conductive metal oxide fine particles which are surface treated with cyclic silazane, another outer-additives may be adhered to the surface of the electrophotographic toner of the present invention in order to control the flow ability, charge ability, cleaning properties, preservation stability and the like, if needed. Examples thereof include; inorganic fine particles which are not treated with cyclic silazane, magnetic powder, talc, clay, calcium carbonate, magnesium carbonate, zinc oxide, silicon carbide, fatty acid metal salts such as magnesium stearate and zinc stearate, various kinds of resin particles and silicone oil.

As a method for adhering an outer additive to matrix toner particles, there is a method wherein mixing is conducted by mixing the outer additive and the matrix toner particles with a general mixer such as, a turbine type mixer, a henschel mixer or a super mixer.

Use of the electrophotographic toner of the present invention is not limited to a specific development method. The electrophotographic toner of the present invention can be used for a magnetic mono-component developing method, a non-magnetic mono-component developing method and a two-component developing method wherein carrier is used. Among them, the magnetic mono-component developing method is preferably applied for the toner of the present invention. Furthermore, there are a contact-type development and a non-contact type development within the mono-component developing method. Although the toner of the present invention can be used for both development methods, the toner of the present invention can show excellent effect in particular when it is used for the non-contact type development.

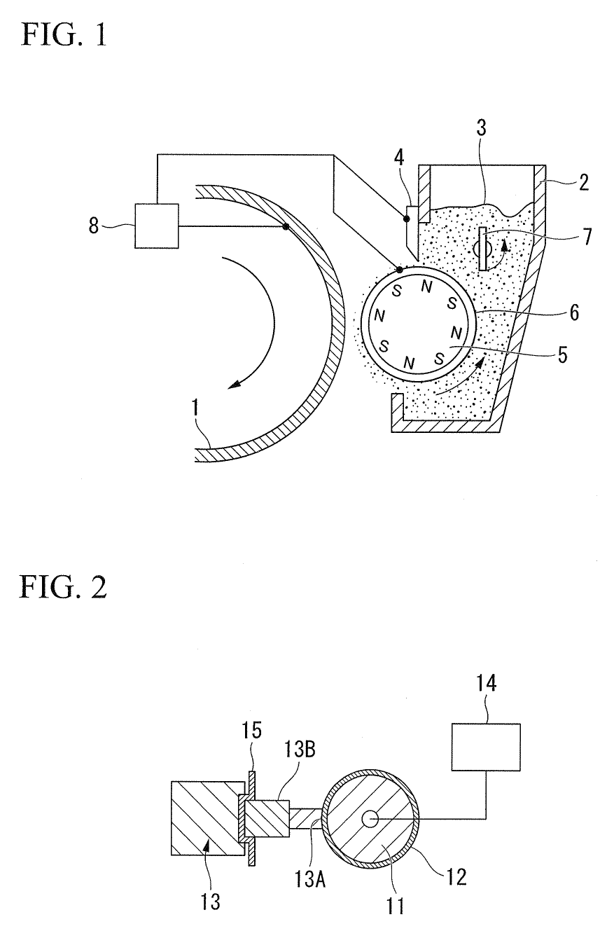

Next, the non-contact, magnetic mono-component development which is the typical application example of the toner of the present invention is explained below using FIG. 1.

FIG. 1 is a schematic view which shows an example of developing equipment used for the non-contact type, magnetic mono-component type development. The developing equipment shown in the FIG. 1 is schematically structured such that, the equipment includes; a cylindrical photoconductor drum 1 which can hold an electrostatic latent image; a hopper 2 in which a magnetic mono-component developer 3 was included; a nonmagnetic sleeve 6 which is provided such that a predetermined interval is provided between the nonmagnetic sleeve 6 and the photoconductor drum 1, and a right half portion of the outside circumference of the sleeve is positioned in the hopper 2 and a left half portion thereof comes face to face with the photoconductor drum 1; a magnetic roller 5 which is built in the nonmagnetic sleeve 6; a charging blade 4 which makes the thickness of a layer of the magnetic mono-component developer uniform; a mixer 7 which mixes the magnetic mono-component developer 3 included in the hopper 2; a power supply 8 by which the nonmagnetic sleeve 6 and the charging blade 4 are maintained in an electrically conducted state, and by which the photoconductor drum 1 is applied alternating bias voltage and direct-current bias voltage. The interval between the nonmagnetic sleeve 6 and the photoconductor drum 1 is about 50 to 400 μm in general.

The noncontact, magnetic mono-component development using this developing equipment is performed as follows. First, an electrostatic latent image is formed on the surface of the photoconductor drum 1 by a well-known electrophotographic method. On the other hand, the magnetic mono-component developer 3 contained in the hopper 2 is holded on the surface of the nonmagnetic sleeve 6 including the magnet roller 5, and then transferred while the predetermined thickness of the developer layer is formed by the charging blade 4. Here, since the power supply 8 applies alternating bias voltage and direct-current bias voltage to the photoconductor drum 1, direct current electric field and alternate current electric field are generated between the nonmagnetic sleeve 6 and the photoconductor drum 1. As the result, transferring of the magnetic mono-component developer 3 existing on the nonmagnetic sleeve 6 to the photoconductor drum 1 causes to develop the latent image on the surface of the photoconductor drum 1.

### EXAMPLES

Hereinafter, the present invention is explained in detail according to the following Examples. In the Example, “part” means “part by weight”. The present invention is not limited only to the Examples.

<Production of Inorganic Fine Particles Treated with Cyclic Silazane>

### (Inorganic Fine Particles 1)

Silica (CAB-O-SIL LM-130 (trade name), manufactured by Cabot corporation) consisting of untreated inorganic fine particles and having a specific surface area of 130 m²/g was treated in accordance with a method described in the paragraph 0036 of Japanese Unexamined Patent Application, First Publication No. Hei 10-330115 (Patent Document 1) using cyclic silazane having the following structural formula. As the result, inorganic fine particles 1 which had been treated with cyclic silazane and had a specific surface area of 125 m²/g was obtained.

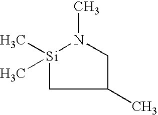

### (Inorganic Fine Particles 2)

Inorganic fine particles 2 which had been treated with cyclic silazane and had a specific surface area of 145 m²/g were obtained similar to the inorganic fine particles 1, except that silica which had a specific surface area of 150 m²/g (CAB-O-SIL LM-150 (trade name), manufactured by Cabot corporation) were used as non-treated inorganic fine particles.

### (Inorganic Fine Particles 3)

Inorganic fine particles 3 which had been treated with cyclic silazane and had a specific surface area of 90 m²/g were obtained similar to the inorganic fine particles 1, except that silica which had a specific surface area of 95 m²/g (CAB-O-SIL L-90 (trade name), manufactured by Cabot corporation) were used as non-treated inorganic fine particles.

### (Inorganic Fine Particles 4)

Inorganic fine particles 4 which had been treated with cyclic silazane and had a specific surface area of 190 m²/g were obtained similar to the inorganic fine particles 1, except that silica which had a specific surface area of 195 m²/g (CAB-O-SIL M-5 (trade name), manufactured by Cabot corporation) was used as non-treated inorganic fine particles.

<Inorganic Fine Particles which have not been Treated with Cyclic silazane>

### (Inorganic Fine Particles 5)

Hydrophobic silica having a specific surface area of 130 m²/g (CAB-O-SIL LM-130 (trade name), manufactured by Cabot corporation)

### <Metal-Oxide Fine Particles>

### (Conductive Metal-Oxide Fine Particles)

Tin and antimony doped titanium oxide: EC-100T-IJ (trade name), manufactured by Titan Kogyo Corporation, average particle diameter 0.35 μm

### (Non-Conductive Metal Oxide Fine Particles)

Titanium oxide; JMT-150ANO (trade name), manufactured by Tayca Corporation, average particle diameter 0.015 μm

### <Carbon Black>

Carbon black; #40 (trade name), manufactured by Mitsubishi Chemical Corporation

### (Production of Matrix Toner Particles)

Raw materials shown below were mixed with a super mixer to form a mixture. After hot-melt kneading of the mixture with a biaxial kneader, the kneaded mixture was subjected to cold-rolling. Then, the mixture was coarsely pulverized with a hammer mill, and furthermore pulverized with an impact type pulverizer (Kriptron Eddy KTM-EX (trade name), manufactured by Kawasaki Heavy Industries, Ltd.). Subsequently, it was classified by a dry type air stream classifier to obtain matrix toner particles having a volume average particle diameter of 8.5 μm and the degree of circularity of 0.94.
Styrene-acrylic acid ester copolymer: 53 parts (CPR-100 (trade name), manufactured by Mitsui Chemicals Inc.)
Polypropylene wax: 2.5 parts (Viscol 550P (trade name), manufactured by Sanyo Chemical Industries, Ltd., melting point; 139° C.)
Fischer-Tropsch wax (natural gas type): 2.5 parts (FT-100 (trade name), commercially available from Nippon Seiro Co., Ltd., melting point; 92.4° C.)
Charge controlling agent (nigrosin type, positive charge): 2 parts, (Bontron N-04 (trade name), manufactured by Orient Chemical Industries, Ltd.)
Magnetite (octahedron): 40 parts (EPT-1002 (trade name), manufactured by Toda Kogyo Corporation, average particle diameter 0.23 μm)

### (Production of Toner)

### Examples 1 and 2, and Comparative Examples 1 to 6

Using a combination of outer additives shown in the Table 1 and 100 parts of the aforementioned matrix toner particles, mixing and stirring were conducted with a Henschel mixer to produced toners of Examples 1 and 2 and Comparative Examples 1 to 6. In the production, inorganic fine particles were added in an amount of 1.0 parts, metal oxide fine particles was added in an amount of 1.0 parts, and carbon black was added in an amount of 0.15 parts.

TABLE 1

| | | | | | Toner |
|---|---|---|---|---|---|
| | | | | Toner layer | consumption |
| | Inorganic fine | Metal oxide fine | | formed on a | (g/1000 |
| | particles | particles | Carbon | sleeve | prints) |
| Ex. 1 | Inorganic fine | EC-100T-IJ | #40 | ◯ | 26 |
| | particles 1 | | | | |
| Ex. 2 | Inorganic fine | EC-100T-IJ | #40 | ◯ | 24 |
| | particles 2 | | | | |
| Com. Ex. 1 | Inorganic fine | EC-100T-IJ | #40 | X | — |
| | particles 3 | | | | |
| Com. Ex. 2 | Inorganic fine | EC-100T-IJ | #40 | ◯ | 23 |
| | particles 4 | | | | |
| Com. Ex. 3 | Inorganic fine | EC-100T-IJ | #40 | ◯ | 20 |
| | particles 5 | | | | |
| Com. Ex. 4 | Inorganic fine | None | #40 | ◯ | 38 |
| | particles 1 | | | | |
| Com. Ex. 5 | Inorganic fine | EC-100T-IJ | None | X | — |
| | particles 1 | | | | |
| Com. Ex. 6 | Inorganic fine | JMT-150ANO | #40 | ◯ | 37 |
| | particles 1 | | | | |

### Toner Evaluation

An A4 manuscript having a black printing ratio of 5% was printed using the toners of Examples 1 and 2 and Comparative Examples 1 to 6 with a commercially available, non-contact type magnetic mono-component development printer (reverse development system, an OPC was used as a photoconductor, printing ratio (A4 vertical direction): 30 prints/minute) which has developing equipment shown in FIG. 1.

First, the state of the toner layer formed on the sleeve was evaluated in the initial stage of printing.

When the aforementioned initial evaluation result of the toner layer was good, the toner was further used for printing in succession, and the charge amount and the image density of the toner were measured at each stage of an initial print, after 2000 sheets were printed, 4000 sheets were printed, 6000 sheets were printed and 30000 sheets were printed to evaluate a long-life property of the toner. After 30000 sheets were printed, toner consumption was determined. The evaluation was conducted at 23° C. and 55% RH.

The valuation methods of each evaluation criteria were as follows.

(1) The State of a Toner Layer Formed on a Sleeve:

A state of a toner layer formed on a sleeve and the condition of a printed image were observed visually.

The evaluation criteria are shown below.
O (Good): Both the thickness of a toner layer formed on a sleeve and the thickness of a printed image were uniform
Δ (Acceptable): Either the thickness of a toner layer formed on a sleeve or the thickness of a printed image was ununiform
× (Poor): Both the thickness of a toner layer formed on a sleeve and the thickness of a printed image were ununiform

(2) Image Density (ID):

Reflection density of a black solid image portion of a printed image was measured by a MacBeth reflective densitometer RD-914.
When image density was 1.35 or more, image density was evaluated as “good”.

(3) Charge Amount:

The developing equipment which included any of toners of Examples 1 and 2 and Comparative Examples 2, 3, 4 and 6 was allowed to stand for 24 hours. Subsequently, the toner was mixed with a mixer included in the developing equipment for ten minutes, and then, the charge amount of the toner was measured with a measuring equipment shown in FIG. 2.

FIG. 2 represents a schematic view of a measuring equipment for measuring charge amount. The equipment includes a vacuum device 13 and a triboelectric charge measuring device 14. Here, in FIG. 2, reference symbol 11 represents a developing roller equipped to the developing equipment, and reference symbol 12 represents a toner attached to the surface of the developing roller. The vacuum device 13 includes a vacuum nozzle 13B having a vacuum inlet 13A on the top position thereof, and is structured such that the vacuum inlet 13A can be moved to the vicinity of the surface of the toner 12 existing on the developing roller 11 to suction the toner 12 into the nozzle. Furthermore, the a vacuum nozzle 13B is structured such that a filter 15 can be provided at an end position thereof which is opposite to another end position at which the vacuum inlet 13A is provided. Two laminated paper filters were used as the filter 15. Here, as the triboelectric charge measuring device 14, a blow-off triboelectric charge amount measuring instrument (Blow-off powder charge amount measuring equipment (trade name), manufactured by Toshiba Chemical Corporation) is used.

Using equipment which was schematically structured as described above, the charge amount of a toner was measured as described below.

First, the filter 15 (two laminated paper filter) was attached to the vacuum nozzle 13B of the vacuum device 13, and then, the mass “ma” (g) of the vacuum nozzle 13B was measured before the vacuum was conducted. Next, the toner 12 adhering to the surface of the developing roller 11 was suctioned by the vacuum device 13 for one minute while the developing equipment was moved 20 cm in a longitudinal direction of the developing roller 11, and the charge quantity “q” (μc) of the suctioned toner 12 was measured. Then, the mass “mb” (g) of the vacuum nozzle 13B was measured after the vacuum was conducted. Subsequently, the mass “m” (g) of the toner 12 which has been vacuumed was determined by the subtraction of mb−ma, and the charge amount A was obtained by the following formula.

A=q/m(μc/g)

The charge amount of the toner was determined such that it was preferable when it was 7.0 μc/g or more.

### (3) Toner Consumption

Toner consumption was measured before make-up toner was supplied when printing was conducted in succession. After 30000 sheets were printed, the total consumption of toner was measured, and the consumption of the toner per 1000 sheets printing (g/1000 prints) was measured. The target toner consumption was 30 g/1000 prints or less.

The evaluation results of the state of a toner layer formed on the developing sleeve and the toner consumption were shown in Table 1.

Furthermore, printing was conducted in succession regarding toners in which the state of a toner layer was good, the charge amount and toner consumption were measured, and the results thereof are shown in Table 2 as follows.

TABLE 2

| | | | 2000 sheets | | 4000 sheets | | 6000 sheets | | 30000 sheets | |
|---|---|---|---|---|---|---|---|---|---|---|
| | Initial stage | | printed | | printed | | printed | | printed | |
| | Charge | | Charge | | Charge | | Charge | | Charge | |
| | amount | | amount | | amount | | amount | | amount | |
| | (μc/g) | ID | (μc/g) | ID | (μc/g) | ID | (μc/g) | ID | (μc/g) | ID |
| Ex. 1 | 8.8 | 1.38 | 7.9 | 1.39 | 8.4 | 1.37 | 8.0 | 1.38 | 8.7 | 1.38 |
| Ex. 2 | 8.0 | 1.38 | 7.5 | 1.37 | 7.6 | 1.36 | 8.1 | 1.35 | 7.8 | 1.35 |
| Com. | 10.0 | 1.40 | 7.0 | 1.35 | 5.3 | 1.30 | 5.0 | 1.25 | 3.5 | 1.23 |
| Ex. 1 | | | | | | | | | | |
| Com. | 6.5 | 1.34 | 5.1 | 1.21 | 4.2 | 1.13 | 4.2 | 1.05 | 3.5 | 0.93 |
| Ex. 3 | | | | | | | | | | |
| Com. | 9.0 | 1.40 | 9.2 | 1.41 | 9.0 | 1.39 | 8.5 | 1.38 | 8.6 | 1.37 |
| Ex. 4 | | | | | | | | | | |
| Com. | 9.0 | 1.40 | 9.2 | 1.41 | 9.0 | 1.39 | 8.5 | 1.38 | 8.6 | 1.37 |
| Ex. 6 | | | | | | | | | | |

### (Evaluation Results)

Regarding the electrophotographic toners of Examples 1 and 2, uniform toner layers were formed on the developing sleeve and uniform printed images were achieved. Furthermore, even in a condition that 30000 sheets were printed in succession, the charge amount was stable, image density did not decrease, and toner consumption was small.

Furthermore, these toners were also used for continuous printing wherein 30000 sheets were printed in succession under the environment of L/L (8° C.: 15% RH) and H/H (33° C.: 83% RH). As the result, toner consumption was small, and both of the charge amount and the image density were stable while printing was continued.

Regarding the toner of Comparative Example 1, the toner layer formed on the sleeve was ununiform since the inorganic fine particles which were surface treated with cyclic silazane but had a specific surface area less than 100 m²/g were used.

Regarding the toner of Comparative Example 2, the charge amount decreased in the printing process which was conducted in succession, and the image density decreased, since the inorganic fine particles which were surface treated with cyclic silazane but had the specific surface area exceeding 175 m²/g was used.

Regarding the toner of Comparative Example 3, the charge amount was small from the initial stage and the charge amount and the image density decreased in the printing process which was conducted in succession, since the inorganic fine particles had not been surface treated with cyclic silazane.

Regarding the toner of Comparative Example 4, toner consumption was large since conductive metal oxide fine particles were not used.

Regarding the toner of Comparative Example 5, toner layer formed on the sleeve was ununiform since carbon black was not used.

Regarding the toner of Comparative Example 6, toner consumption was large since used metal oxide fine particles were not conductive particles.

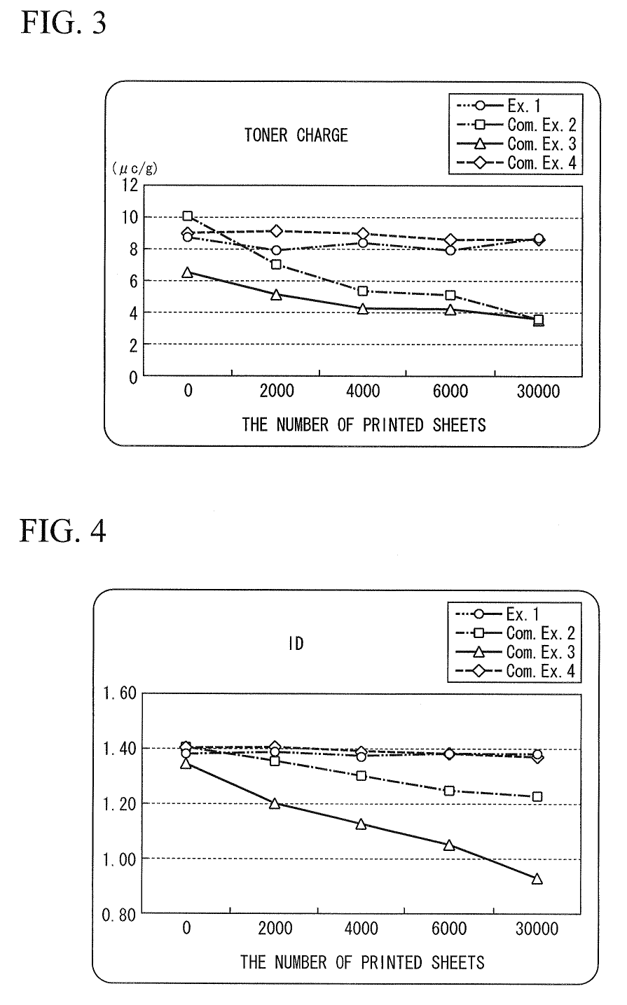

In order to show the differences between Examples and Comparative Example clearly, the relationship between the number of prints and the charge amount is shown in FIG. 3, and relationship between the number of prints and the image density (ID) is shown in FIG. 4.

### INDUSTRIAL APPLICABILITY

The electrophotographic toner can be used for any development, and can be used for methods such as a two-component developing method, a magnetic mono-component developing method and a non-magnetic mono-component developing method.

1. An electrophotographic toner wherein at least inorganic particles, conductive metal oxide fine particles and carbon black are adhered to the surface of matrix toner particles, and the inorganic particles are surface-treated with cyclic silazane and have a specific surface area of 100 to 175 m²/g.

2. The electrophotographic toner according to claim 1, wherein the toner has the degree of circularity of 0.890 to 0.975, and the degree of circularity is obtained by the following formula (1);
Degree of circularity=π×(diameter of a circle which has the same area as an image of a particle to be evaluated)/perimeter of the image of the particle (1).

3. The electrophotographic toner according to claim 1 or 2, wherein the toner is used for mono-component development.

4. The electrophotographic toner according to claim 3, wherein the toner is used for non-contact, type mono-component development.

5. The electrophotographic toner according to any of claims 1 to 4, wherein the toner is a magnetic toner.
